(19) United States
(12) Patent Application Publication
(10) Pub. No.: US 2008/0120234 A1
(43) Pub. Date: May 22, 2008

(54) Variable Revenue Sharing For Multiple Account Payment Instruments

(75) Inventors: Jason Jagatic, Providence, RI (US); Seshadri Kulkarni, Pine Brook, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/561,326

(22) Filed: Nov. 17, 2006

(51) Int. Cl. G06Q 20/00

(52) U.S. Cl. 705/44

(57) ABSTRACT

A method and system are disclosed for facilitating allocation of payments among multiple transaction instrument partners. The method and system comprises receiving at a network a transaction authorization request from a merchant; determining the total amount of merchant fee to be charged for the total transaction; subtracting from the total amount of the merchant fee a predetermined portion for retention by the network; transmitting the balance of the merchant fee to a card issuer; and allocating at the issuer portions of the balance of the merchant fee to be allocated among two or more transaction instrument partners.

### CROSS-REFERENCE TO RELATED APPLICATIONS

This invention is related to the disclosures of commonly owned U.S. patent application Ser. No. 10/904,639, filed Nov. 19, 2004; U.S. patent application Ser. No. 11/275,399, filed Dec. 29, 2005; U.S. patent application Ser. No. 11/275,401, filed Dec. 29, 2005; U.S. patent application Ser. No. 11/275,403, filed Dec. 29, 2005; and U.S. patent application Ser. No. 11/275,405, filed Dec. 29, 2005; the disclosures of which are incorporated herein in their entirety.

### BACKGROUND OF THE INVENTION

1. Field of the Invention

This invention generally relates to a system and method for administering and allocating payments among multiple transaction instrument partners.

2. Related Art

Fundamental changes are occurring in the healthcare industry with respect to expenditures by consumers. Healthcare expenditures in the U.S. are expected to increase from approximately $558B in 1988 to approximately $3,361B by 2013. It is projected that consumers will pay a larger share of those expenditures, from approximately 14% in 2001 to an expected 19% in 2010.

Section 125 of the United States Internal Revenue Code offers tax savings to employees for medical, dependent care and childcare expenses. Likewise, Section 132 of the United States Internal Revenue Code offers employees tax savings for work-related parking and transportation expenses. For example, employees may be entitled to tax benefits if the employees withhold a portion of their payroll to pay for medical, dependent care, childcare, work-related parking expenses and/or work-related transportation expenses. In other words, the employees' payroll is taxed on the amount left after the withheld portion is subtracted from the payroll amount and the withheld portion is placed into a flexible spending account.

How consumers pay for healthcare expenditures also is changing. Presently, less than 20% of consumer healthcare payments is through use of “plastic,” which includes debit cards, charge cards, and credit cards. This percentage is expected to grow by over 10% in five years to approximately 30% by 2010.

Another fundamental change that is expected to occur in the healthcare industry is the increase in use of tax advantaged plans as part of the shift to consumer directed healthcare (CDHC). Typically both employers and employees receive tax benefits for participating in these programs, Three tax advantaged plans of most interest include: the Flexible Spending Account (“FSA”); the Health Savings Account (“HSA”); and the Healthcare Reimbursement Arrangement (“HRA”).

The shift towards CDHC, while providing tax and other benefits to employers and/or employees, also entails significant administrative costs. These costs include, for example, the costs associated with maintaining individual accounts for each participating employee. Additionally, providers of healthcare goods/services often encounter significant delays in payment from account administrators, due to the amount of time necessary to substantiate receipts and to determine the respective payment responsibilities of the insurers and the employees. Currently, each type of plan requires a separate card to be presented to the provider in payment of the good or service rendered. This is very inconvenient for the consumer.

Given the foregoing, what is needed is a system and a method for administering multiple tax advantaged accounts, which minimize the administrative costs and which facilitates the process for allocating transaction fees among transaction instrument partners.

### BRIEF SUMMARY OF THE INVENTION

The method and system of this invention comprises receiving at a network a transaction authorization request from a merchant; determining the total amount of merchant fee to be charged for the total transaction; subtracting from the total amount of the merchant fee a predetermined portion for retention by the network; transmitting the balance of the merchant fee to a card issuer; and allocating at the issuer portions of the balance of the merchant fee to be allocated among two or more transaction instrument partners.

### BRIEF DESCRIPTION OF THE DRAWINGS/FIGURES

The features and advantages of the present invention will become more apparent from the description set forth below when taken in conjunction with the drawings in which like reference numbers indicate identical or functionally similar elements.

FIG. 1 schematically shows the process of a transaction authorization process according to the present invention.

FIG. 2 presents the data and financial flow between different entities occurring as part of the authorization process.

FIG. 3 shows an example of the financial flow between different entities occurring as part of the settlement process.

FIG. 4 is a block diagram of an exemplary computer system for use with the system and method of this invention.

### DESCRIPTION OF THE INVENTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

### Terminology

The term “merchant” as used herein means any person, entity, distributor system, software, and/or hardware that is a provider, broker, and/or any other entity in the distribution chain of goods or services. For example, a merchant may be a credit card issuer, a hotel chain, an airline, a grocery store, a retail store, a travel agency, a service provider, including, but not limited to, a medical service provider, an online merchant, or the like.

A “transaction account” as used herein refers to an account associated with an open account card or a closed account card system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a card that may only be accepted at a clothing retailer, such as a Saks Fifth Avenue® store.

The term “transaction instrument” as used herein may include any type of open or closed charge card, credit card, debit card, FSA card, stored value card, an RFID chip based card or token, and the like. For convenience, a transaction instrument may be referred to as a “card.”

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder, radio frequency card or payment statement).

Partners, as used herein, generally may include an entity that administers an account that is associated with a transaction instrument. Such programs include, but are not limited to, health plans and third party administrators (TPAs) which manage tax advantaged plans for employers who offer such plans and, in some instances, to employees as well. Examples of tax advantaged plans include: Flexible Spending Accounts (“FSA”); and Health Savings Accounts (“HSA”).

Persons skilled in the relevant arts will understand the breadth of the terms used herein and that the exemplary descriptions provided are not intended to be limiting of the generally understood meanings attributed to the foregoing terms.

### Overview

The invention is directed to facilitating the processing of fee payments to multiple accounts or “purses” that are tied to a single transaction instrument or card. The accounts or “purses” may include one or more health plans, such as an FSA, and/or an HSA, and/or a line of credit (LOC) associated with the card. A card member may therefore be able to charge both tax advantaged and general purchases of good and services to the same card. In some examples, a multi-account card can only be used with certain merchants, specifically those that are coded for tax advantaged purchases, such as doctors, dentists, optometrists, drug stores, pharmacies, etc. In other examples, the multi-account card can be used generally with any merchant.

A payment network receives transaction data, including the total amount of the transaction. The payment network determines the total transaction fee (sometimes called “interchange”) and transmits that information to a processor and a card issuer. The Issuer allocates shares of the transaction fee with the payment network and the one or more account administrators, such as the FSA administrator, the HSA administrator and a line of credit (LOC) administrator. This permits a single card to be used for multiple types of transactions, such as for both tax-advantaged health care transactions among different types of providers and regular non-tax advantaged transactions, such as store purchases and the like. Typically, where a single transaction includes both tax advantaged and general purchases, a third party administrator will determine which parts of the transaction are to be routed to tax advantaged purses (e.g. an FSA or HSA) and which are to be routed to a general purse, such as an LOC.

Further details of embodiments of this invention are described below.

### Embodiments

The following embodiments describe a process of transaction fee allocation and settlement according to the present invention. The relevant parties in this process include the following:

A Provider or Merchant (e.g., doctor, hospital, druggist, dentist, optometrist, or any other health care provider) provides goods and/or services to a Card Member (CM) for which payment is sought upon completion of a transaction.

An Acquirer has a business relationship with merchants and receives all credit card transactions from the merchants. The Acquirer then routes the transaction(s) to an appropriate network. The Acquirer may be thought of as a clearinghouse between merchants and the one or more networks with which the Acquirer is associated. A portion of the Card Member's card number identifies the network that issued the card, e.g., Visa®, MasterCard® and Discover®, etc. The Acquirer reads the card number transmitted by the Provider and routes the transaction to the appropriate Network.

A Network may be associated with one or more Issuers. For example, the Visa® Network may be associated with Bank of America, Capital One, Chase, Citigroup, etc. Similarly, the MasterCard® Network may be associated with Sun Trust, MBNA, and/or issuers that are also part of the Visa Network. The Network passes card transaction authorization requests and decisions between merchants or service establishments and an appropriate Issuer. The Network generates financial settlement reports, as will be discussed in more detail below.

An Issuer issues transaction instruments, (e.g., credit cards, charge cards, debit cards, etc.). The Issuer also underwrites a line of credit (LOC) associated with the transaction instrument; and shares interchange/discount revenue from FSA and HSA related card transactions with a third party administrator (TPA) and one or more health plans. Examples of Issuers may be Bank of America, Citigroup, American Express, Capital One, etc.

A Processor makes card transaction authorization decisions (e.g., approve or decline transactions) based on business rules provided by the Issuer.

A Third Party Administrator (TPA) or a Card Platform (CP) provides healthcare administrative services to employers and validates that purchases made with a healthcare card are qualified medical expenses following Internal Revenue Service (IRS) requirements.

Health plans process claims submitted by medical service providers to determine patient and insurance portions.

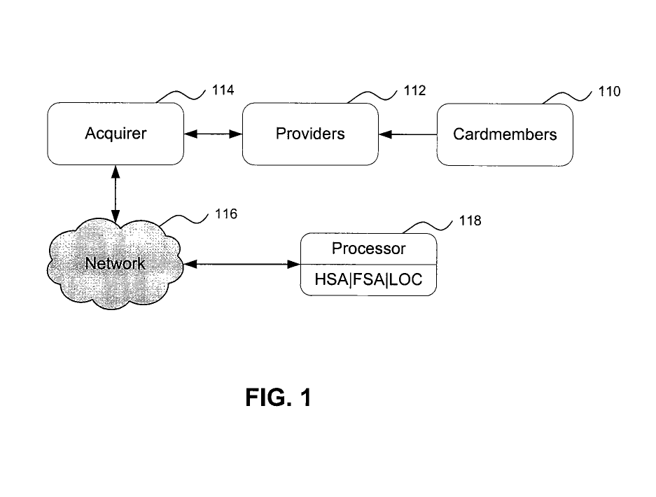

Referring now to the drawings, FIG. 1 is a diagrammatic view of the transaction authorization process according to the invention. A CM 110 obtains goods or services from a Provider 112. Provider 112 may be a doctor or pharmacy, in which case the doctor's fees would typically be covered by an HSA; if the provider is a dentist or optometrist, typically the cost of the goods or service will be allocated to an FSA. It should be understood that these allocations are exemplary only and are dependent in part on tax laws in effect at any given time.

Provider 112 swipes the CM's card at the point of sale (POS) to obtain authorization to charge the CM's card for the transaction. The authorization request is sent to an Acquirer 114. Acquirer 114 reads the account number and routes the transaction request to an appropriate Network 116. Network 116 sends the authorization request to a Processor 118. Processor 118 verifies the card expiration date, the merchant category, the order in which funds to honor the transaction request should be drawn from an HSA, FSA, or LOC, the amount of the funds that are available in each purse or account, and then sends an approval or denial decision back to Network 116. Processor 118 keeps a record of all transactions and the purse (or account) from which funds are drawn.

The process of FIG. 1 typically occurs continuously as each transaction authorization request is received by Acquirer 114 and Network 116.

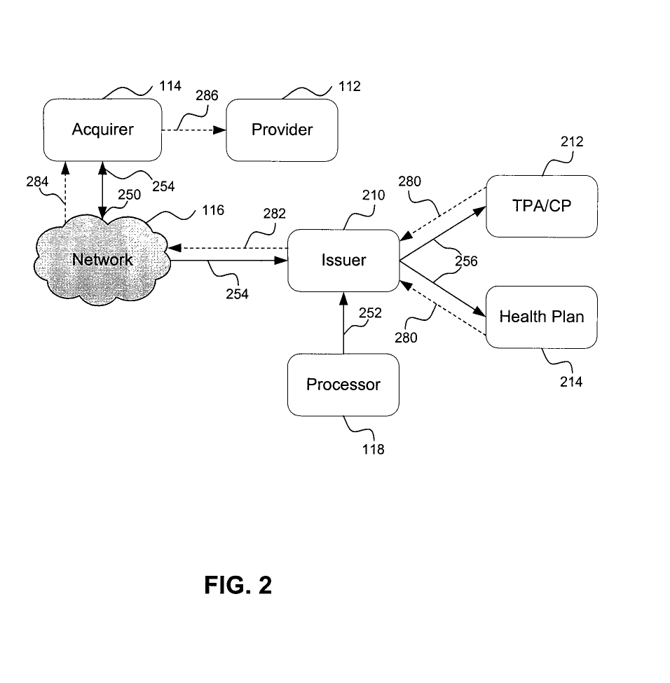

FIG. 2 presents the data and financial flow between different entities occurring as part of the settlement process.

Data flow in the process proceeds as follows:

In step 250, Acquirer 114 submits all approved transactions to Network 116 for clearing and settlement.

In step 254, Network 116 generates and delivers financial settlement reports containing approved transactions to Acquirer 114 and Issuer 210. These financial settlement reports will be described in more detail below.

In step 252, Processor 118 sends a file to Issuer 210 with the same transaction information but broken down by purses. Thus the transaction information from Processor 118 instructs Issuer as to which purses or accounts to charge for the transaction Using the merchant category and purse information supplied by Processor 118, Issuer 210 routes the transaction to a Third Party Administrator (TPA) 212 or a Health Plan 214. This in turn determines the share of interchange that is retained by TPA 212 and Health Plan 214, as will be described in more detail below.

Finally, in step 256, Issuer 210 generates and delivers financial settlement reports to TPA 212 and Health Plans 214, also as discussed in more detail below.

As noted above, Acquirer 114 submits approved transactions to Network 116 for clearing and settlement. Every merchant transaction conducted with a transaction instrument is subject to a merchant fee, sometimes called an interchange or merchant discount rate. This merchant discount rate is typically calculated in terms of basis points (bps) which are equivalent to percentage points. Merchant discount rates typically range from 100 bps to 600 bps (equivalent to 1%-6% of the transaction amount), with the usual rate being on the order of 200 bps-300 bps (2%-3% of the transaction amount). It will be apparent to persons skilled in the relevant arts that these numbers are exemplary only and that the present invention is not dependent on any specific discount rate.

Network 116 validates and clears the transactions submitted by Acquirer 114 for inclusion in a financial settlement report. Network 116 sends the financial settlement report to Issuer 210 and collects a predetermined and fixed share of the interchange or discount revenue on reported transactions with the Issuer. Network 116 then settles with (pays) Acquirer 114 its share of the interchange.

Processor 118 sends the list of approved transactions by “purse” or account (e.g., the FSA, HSA, and/or LOC) to Issuer 210. Issuer 210 then reconciles the list of approved transactions by purse with the financial settlement report from Network 116 for subsequent settlement with each party involved with each purse per the agreed upon amount.

Typically, the data flow and settlement process of FIG. 2 is conducted on a batch basis, for example, once a day. It will be understood by persons skilled in the relevant arts that the process could be conducted continuously or alternatively less often than once a day.

Financial flow is as follows:

At step 280, Issuer 210 settles with TPA 212 and Health Plan 214. TPA 212 transmits total FSA spend minus its share of the discount revenue to Issuer 210. Health Plan 214 transmits HSA spend minus its share of the discount revenue to Issuer 210.

At step 282, Network 116 settles with Issuer 210 for card transactions in the Issuer financial settlement report. Issuer 210 transmits total spend on the card minus its, the TPA, and the Health Plan share of the discount revenue to Network 116.

At step 284, Network 116 settles with Acquirer 114. Network 116 transmits the amount received from Issuer 210 to Acquirer 114 minus its share of the discount revenue.

At step 286, Acquirer 114 settles with Provider 112. Acquirer 114 transmits the amount received from Network 116 to Provider 112 minus its share of the discount revenue.

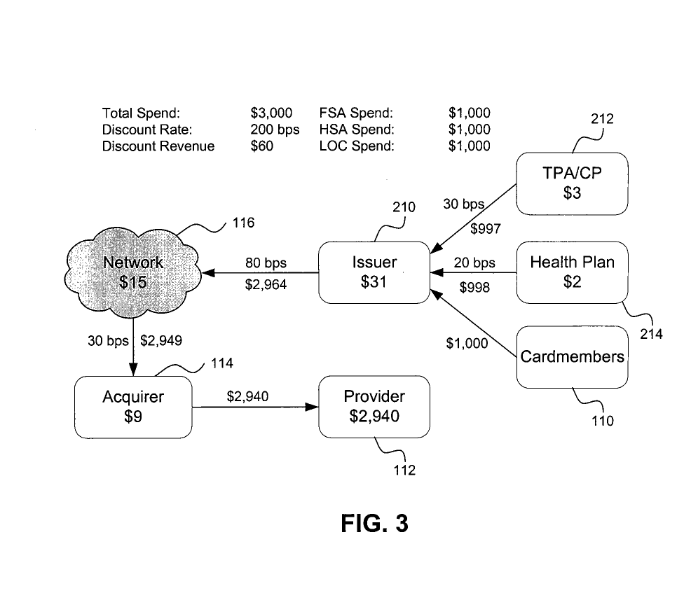

FIG. 3 shows an example of how all the entities share the discount or interchange revenue.
Assume the merchant discount rate is 200 bps (2% of transaction amounts)
Assume Acquirer 114 receives 30 bps (0.3%) of the total spend (i.e., FSA, HSA, LOC), Network 116 receives 50 bps (0.5%) of the total spend, TPA 212 receives 30 bps (0.3%) of FSA spend only, and Health Plan 214 receives 20 bps (0.2%) of HSA spend only
Assume CM 110 has an FSA spend of $1,000, an HSA spend of $1,000, and a LOC spend of $1,000.

The total transaction amount processed through Network 116 is $3,000. The interchange or discount revenue generated from all the transactions processed is $60 (based on the merchant discount rate of 200 bps). The funds to pay Provider 112 are drawn from one or more of TPA 212 (representing the FSA), Health Plan 214, and CM 110. In this example, FSA spend was $1,000. Therefore TPA 212 transmits $997 (representing the $1,000 FSA spend less the TPA share of the interchange, which is $3.00) to Issuer 210. HSA spend is $1,000. Therefore Health Plan 214 transmits $998 (representing the $1,000 HSA spend less the Health Plan share of the interchange, which is $2.00) to Issuer 210. CM 110 (which does not share in the interchange) transmits $1,000 to Issuer 210.

The combined share of the interchange for Network 116 and Acquirer 112 is 80 bps (or $24.00). Issuer 210 retains $31.00 of the interchange ($60 (total)−$3 (TPA share)−$2 (Health Plan share)−$24 (combined Network+Acquirer share)) and transmits $2,964 to Network 116. Network 116 retains $15 (50 bps) and transmits $2,949 to Acquirer 114. Acquirer 114 retains $9.00 (30 bps) and transmits $2,940 to Provider 112. Revenue could also be shared on a fixed fee basis or per transaction.

In a variation of the foregoing example, assume that the FSA purse only has $800 in available funds. If the FSA spend is $1000, the $800 will be drawn from the FSA and the remaining $200 will be taken from the LOC purse. In that event, TPA 212 will only retain $2.40 (30 bps on $800 FSA spend). Issuer 210, as the holder of the LOC purse, will receive the balance, or $0.60, in addition to its normal share of the interchange.

Again, as noted above, the foregoing are merely examples of the variable revenue sharing arrangement of the present invention. It will be apparent to persons skilled in the relevant arts that variations of the foregoing example are both possible and contemplated.

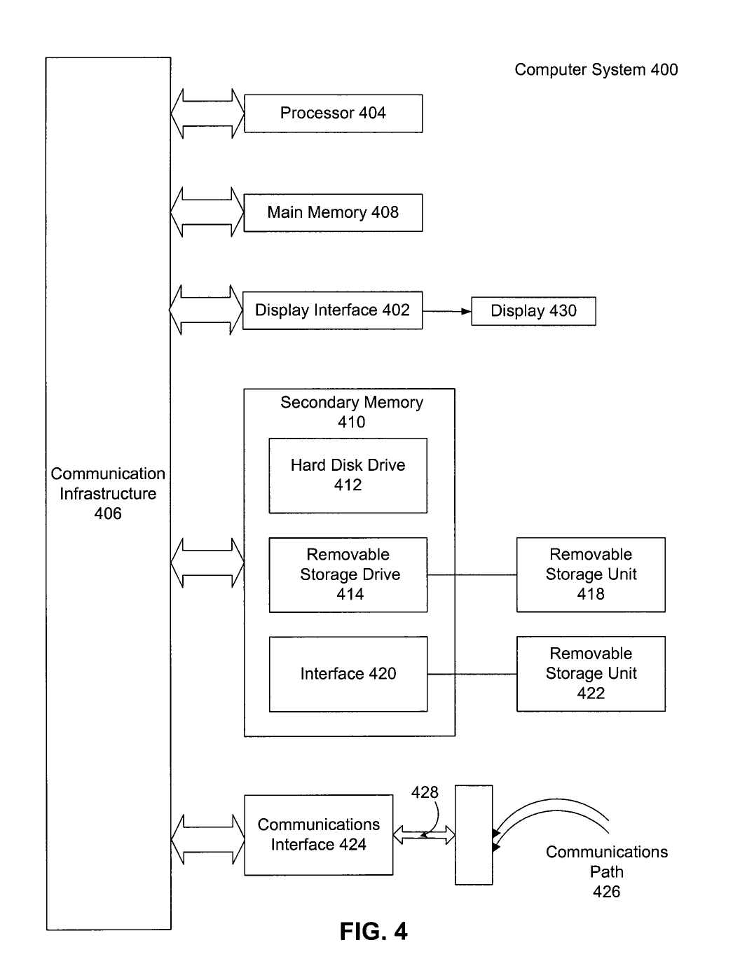

In one embodiment, the invention is directed toward one or more computer systems capable of carrying out the functionality described herein. An example of a computer system 400 capable of carrying out the functions of this invention is shown in FIG. 4.

Computer system 400 includes one or more processors, such as processor 404. Processor 404 is connected to a communication infrastructure 406 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from communication infrastructure 406 (or from a frame buffer not shown) for display on display unit 416.

Computer system 400 also includes a main memory 408, preferably random access memory (RAM), and may also include a secondary memory 410. Secondary memory 410 may include, for example, a hard disk drive 412 and/or a removable storage drive 414, representing a floppy disk drive, a magnetic tape drive, an optical disk drive, etc. Removable storage drive 414 reads from and/or writes to a removable storage unit 418 in a well known manner. Removable storage unit 418 represents a floppy disk, magnetic tape, optical disk, etc. which is read by and written to by removable storage drive 414. As will be appreciated, removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 414, a hard disk installed in hard disk drive 412, and signals 428. These computer program products provide software to computer system 400. The invention is directed to such computer program products.

Computer programs (also referred to as computer control logic) are stored in main memory 408 and/or secondary memory 410. Computer programs may also be received via communications interface 424. Such computer programs, when executed, enable computer system 400 to perform the features of the present invention, as discussed herein. In particular, the computer programs, when executed, enable processor 404 to perform the features of the present invention. Accordingly, such computer programs represent controllers of computer system 400.

In an embodiment where the invention is implemented using software, the software may be stored in a computer program product and loaded into computer system 400 using removable storage drive 414, hard drive 412 or communications interface 424. The control logic (software), when executed by processor 404, causes processor 404 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention (e.g., packaging and activation of other transaction cards and/or use of batch activation processes). Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method for facilitating allocation of payments among multiple transaction instrument partners, comprising:
receiving at a network a transaction authorization request from a merchant;
determining a total amount of a merchant fee to be charged for a total transaction amount;
subtracting from the total amount of the merchant fee a predetermined portion for retention by the network;
transmitting a balance of the merchant fee to a transaction instrument issuer; and
allocating portions of the balance of the merchant fee among two or more transaction instrument partners by:
determining an interchange amount as a function of the transaction amount;
determining a first portion of the transaction to be charged to a first transaction instrument partner;
determining a second portion of the transaction to be charged to a second transaction instrument partner;
receiving from the first transaction instrument partner the first portion of the transaction amount less a first interchange share retained by the first partner;
receiving from the second partner the second portion of the transaction amount less a second interchange share retained by the second partner; and
retaining at the issuer at least a portion of the balance of the interchange amount.

2. The method according to claim 1, further comprising:
transmitting a discounted amount of the total transaction amount to the provider.

3. (canceled)

4. The method according to claim 4, further comprising:
determining the first interchange share as a function of the first portion of the transaction amount transmitted by the first partner.

5. The method according to claim 4, wherein:
if the first partner does not have sufficient funds to cover the first portion of the transaction amount, then transmitting less than the full amount of the first portion and transmitting the balance of the first portion from a further partner; and
determining the first interchange share as a function of the amount transmitted by the first partner.

6. The method according to claim 5, wherein the further partner comprises a line of credit associated with the transaction instrument.

7. A method for allocating interchange payments among multiple transaction instrument partners, comprising:
transmitting a transaction authorization request from a merchant;
receiving the transaction authorization request at a network;
transmitting the transaction authorization request from the network to a transaction instrument issuer and a transaction processor;
determining at the processor the merchant category, the validity of the transaction instrument, and the order in which funds to honor the transaction should be drawn from one or more transaction instrument partners;
transmitting at least a part of the transaction authorization request from the issuer to at least one of first and second transaction instrument partners based on information obtained by the issuer from the processor;
transmitting from the at least one transaction instrument partner to the issuer at least a portion of the requested transaction amount less an interchange share retained by the at least one transaction instrument partner; and
transmitting from the issuer to the merchant the requested transaction amount less an interchange share retained by the issuer.

8. The method according to claim 7, further comprising:
transmitting at least a further part of the transaction authorization request from the issuer to at least the second of the transaction instrument partners based on information obtained by the issuer from the processor; and
transmitting from the second transaction instrument partner to the issuer at least a portion of the requested transaction amount less an interchange share retained by the second transaction instrument partner.

9. A system for allocating interchange payments among multiple transaction instrument partners, comprising:
a plurality of transaction instrument partners that contain funds to fund transaction requests; and
a transaction instrument issuer that receives a transaction amount authorization request from a merchant;
determines an interchange amount as a function of the transaction amount;
determines a first portion of the transaction to be charged to a first transaction instrument partner;
receives from the first partner the first portion of the transaction amount less a first interchange share retained by the first partner;
determines whether a second portion of the transaction is to be charged to a second transaction instrument partner, and, if so,
receives from the second partner the second portion of the transaction amount less a second interchange share retained by the second partner; and
retains at least a portion of the balance of the interchange amount.

10. The system according to claim 9, wherein:
the first interchange share is determined as a function of the first portion of the transaction amount transmitted by the first partner.

11. The system according to claim 10, further comprising:
a line of credit account associated with a transaction instrument from which funds may be withdrawn to cover at least part of the first portion of the transaction amount if the first partner does not have sufficient funds to cover the entirety of the first portion of the transaction amount, wherein the first partner's interchange share is determined as a function of the amount transmitted by the first partner.

12. A computer program product comprising a computer useable medium including control logic stored therein for use in facilitating allocation of payments among multiple transaction instrument partners, comprising:
first control logic means for enabling the computer to receive at a network a transaction authorization request from a merchant;
second control logic means for enabling the computer to determine a total amount of a merchant fee to be charged for the total transaction;
third control logic means for enabling the computer to subtract from the total amount of the merchant fee a predetermined portion for retention by the network;
fourth control logic means for enabling the computer to transmit a balance of the merchant fee to a processor; and
fifth control logic means for enabling the computer to allocate at the processor portions of the balance of the merchant fee to be allocated among two or more transaction instrument partners.

13. The computer program product according to claim 12, further comprising:
sixth control logic means for enabling the computer to notify a third party to pay the discounted amount to the provider.

14. A computer program product comprising a computer useable medium including control logic stored therein for use in allocating interchange payments among multiple transaction instrument partners, comprising:
first control logic means for enabling the computer to receive at an issuer a transaction amount authorization request from a merchant;
second control logic means for enabling the computer to determine an interchange amount as a function of the transaction amount;
third control logic means for enabling the computer to determine a first portion of the transaction to be charged to a first transaction instrument partner;
fourth control logic means for enabling the computer to determine a second portion of the transaction to be charged to a second transaction instrument partner;
fifth control logic means for enabling the computer to receive from the first partner the first portion of the transaction amount less a first interchange share retained by the first partner;
sixth control logic means for enabling the computer to receive from the second partner the second portion of the transaction amount less a second interchange share retained by the second partner; and
seventh control logic means for enabling the computer to retain at the issuer at least a portion of the balance of the interchange amount.

15. The computer program product according to claim 14, further comprising:
eighth control logic means for enabling the computer to determine the first interchange share as a function of the first portion of the transaction amount transmitted by the first partner.

16. The computer program product according to claim 15, further comprising:
ninth control logic means for enabling the computer to transmit less than the full amount of the first portion if the first partner does not have sufficient funds to cover the first portion of the transaction amount, and to transmit the balance of the first portion from a further partner; and
tenth control logic means for enabling the computer to determine the first interchange share as a function of the amount transmitted by the first partner.

17. The computer program product according to claim 16, wherein the further partner comprises a line of credit associated with the transaction instrument.
